(19) United States
(12) Patent Application Publication
(10) Pub. No.: US 2012/0056705 A1
(43) Pub. Date: Mar. 8, 2012

(54) LAYERED INDUCTOR AND MANUFACTURING METHOD THEREOF

(75) Inventors: Sung Lyoung KIM, Bucheon (KR); Jin Woo HAHN, Yongin (KR); Ic Seob KIM, Yongin (KR); Sung Yong AN, Anyang (KR); Soo Hwan SON, Seoul (KR)

(73) Assignee: SAMSUNG ELECTRO-MECHANICS CO., LTD., Gyunggi-do (KR)

(21) Appl. No.: 13/007,023

(22) Filed: Jan. 14, 2011

(30) Foreign Application Priority Data
Sep. 7, 2010 (KR) 10-2010-0087510

(51) Int. Cl. H01F 5/02; H01F 7/06

(52) U.S. Cl. 336/200; 29/602.1

(57) ABSTRACT

There is provided a layered inductor and a manufacturing method of the layered inductor. There is provided a layered inductor, comprising: a main body in which a plurality of non-magnetic layers are stacked; coil parts ha-ving a plurality of conductor patterns and a plurality of via electrodes formed on the plurality of non-magnetic layers; a plurality of magnetic paths formed in the inner central portion of the coil parts and passing the magnetic flux induced from the coil parts therethrough; and first and second external electrodes formed on the external surface of the main body to be connected to both ends of the coil part, respectively.

### CROSS-REFERENCE TO RELATED APPLICATIONS

This application claims the priority of Korean Patent Application No. 10-2010-0087510 filed on Sep. 7, 2010, in the Korean Intellectual Property Office, the disclosure of which is incorporated herein by reference.

### BACKGROUND OF THE INVENTION

1. Field of the Invention

The present invention relates to a layered inductor and a manufacturing method thereof, and more particularly, to a layered inductor with the improved inductance characteristics of a layered inductor of completely shielding a magnetic flux around an internal coil, and a manufacturing method thereof.

2. Description of the Related Art

An inductor, which is one of a plurality of important passive devices configuring an electronic circuit, together with a resistor and a capacitor, has been used as a component to remove noise or to configure an LC resonance circuit. The inductor may be manufactured by winding or printing a coil on a ferrite core and forming electrodes on both ends thereof. Further, the inductor may be manufactured by printing and stacking internal electrodes on a magnetic material or a dielectric material.

The inductor may be classified as a layered type, a winding type, a thin film type, or the like . Among the various types of inductor, a layered inductor has been prevalently propagated. The layered inductor according to the related art includes a plurality of magnetic sheets (made of ferrite or a dielectric material having a low dielectric constant). Conductor patterns having a coil shape are formed on the magnetic sheets. The conductor patterns having a coil shape formed on each magnetic sheet form internal electrode layers. The internal electrode layers having a metal pattern, which are formed on the magnetic sheets, may be formed by using a printing method referred to as screen printing. In this case, a conductive material, printed to form the metal pattern, is generally in a conductive paste state included in an organic solvent, or the like. Further, the internal electrode layers are electrically connected in series through via electrodes formed on a ferrite sheet. The layered inductor may be manufactured as a separate component having a chip shape and may be formed in a state in which it is embedded in a substrate, together with other modules.

A general layered inductor has a structure in which a plurality of magnetic layers formed with the conductor patterns are layered, wherein the conductor patterns are sequentially connected by the via electrodes formed on each magnetic layer to form a spiral coil while being overlapped according to a layered direction. Further, the layered inductor has a structure in which both ends of the coil are drawn out to an outer surface of a laminate and connected with external terminals.

As described above, since the layered inductor has a structure in which the coil is surrounded by a magnetic material such as ferrite, the magnetic material around the coil is magnetized when high current is applied to the coil. There is a problem in that the inductance characteristics of the inductor are deteriorated due to the change in inductance (L) value of the inductor by the magnetization of the vicinity of the coil.

### SUMMARY OF THE INVENTION

An aspect of the present invention provides a layered inductor with the improved inductance characteristics of a layered inductor of shielding a magnetic flux formed around a coil of a layered inductor to prevent the vicinity of a coil from being magnetized even at high current, and a manufacturing method thereof.

According to an aspect of the present invention, there is provided a layered inductor, including: a main body in which a plurality of non-magnetic layers are stacked; coil parts having a plurality of conductor patterns and a plurality of via electrodes formed on the plurality of non-magnetic layers; a plurality of magnetic paths formed in the coil parts and passing the magnetic flux induced from the coil parts therethrough; and first and second external electrodes formed on the external surface of the main body to be connected to both ends of the coil part, respectively.

The plurality of magnetic paths may be formed in an inner central portion of the coil part to pass the magnetic flux induced from the coil part therethrough.

The plurality of magnetic paths may be formed in the inner central portion and the inner peripheral portion of the coil part to pass the magnetic flux induced from the coil part therethrough.

The number of magnetic paths formed in the inner central portion of the coil part may be set to be larger than that of the inner peripheral portion of the coil part to induce the flow of magnetic flux to the inner central portion of the coil.

The size of the magnetic path formed in the inner central portion of the coil part is set to be larger than that of the magnetic path at the inner peripheral portion of the coil part to induce the flow of magnetic flux to the central portion.

The magnetic path may include a magnetic ceramic.

The non-magnetic layer may include a non-magnetic ceramic sheet.

According to another aspect of the present invention, there is provided a manufacturing method of a layered inductor, including: preparing a plurality of non-magnetic layers each formed to have a plurality of via electrodes and a plurality of conductor patterns; punching a plurality of via holes in an inside surrounded by conductor patterns formed on the non-magnetic layers; forming a plurality of magnetic paths by filling the plurality of via holes with a magnetic material; stacking a plurality of non-magnetic layers to form a coil structure by connecting adjacent conductor patterns to the plurality of via electrodes; and forming a first external electrode and a second external electrode at both ends of the stacked non-magnetic layer to be connected to both ends of the coil structure.

During the punching of the via holes, the plurality of via holes may be punched through the inner central portion surrounded by the conductor patterns. Further, the plurality of via holes may be punched through the inner central portion and the inner peripheral portion surrounded by the conductor patterns.

A larger number of via holes than that of the inner peripheral portion surrounded by the conductor patterns are punched through the inner central portion surrounded by the conductor patterns.

The via holes having a larger size than the inner peripheral portion surrounded by the conductor patterns are punched through the inner central portion surrounded by the conductor pattern.

The plurality of via holes may be filled with a magnetic paste.

The magnetic paste may include magnetic ceramic powder.

The non-magnetic layer may be a non-magnetic ceramic sheet.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an external perspective view showing an example of a layered inductor according to an exemplary embodiment of the present invention;

FIG. 2 is a perspective view of a layered inductor according to the exemplary embodiment of the present invention shown in FIG. 1;

FIG. 3 is an exploded perspective view of a layered inductor according to an exemplary embodiment of the present invention shown in FIG. 2;

FIGS. 4A to 4C are plan views showing magnetic paths formed on non-magnetic sheets according to various exemplary embodiments of the present invention; and

FIGS. 5A and 5B are cross-sectional views of the layered inductor according to the exemplary embodiment of the present invention.

### DETAILED DESCRIPTION OF THE PREFERRED EMBODIMENT

Hereinafter, exemplary embodiments will now be described in detail with reference to the accompanying drawings so that they can be easily practiced by a person skilled in the art to which the present invention pertains. However, in describing the exemplary embodiments of the present invention, detailed descriptions of well-known functions or constructions are omitted so as not to obscure the description of the present invention with unnecessary detail.

In addition, like reference numerals denote parts performing similar functions and actions throughout the drawings.

Throughout this specification, when it is described that an element is “connected” to another element, the element may be “directly connected” to another element or “indirectly connected” to another element through a third element. In addition, unless explicitly described otherwise, “comprising” any components will be understood to imply the inclusion of other components but not the exclusion of any other components.

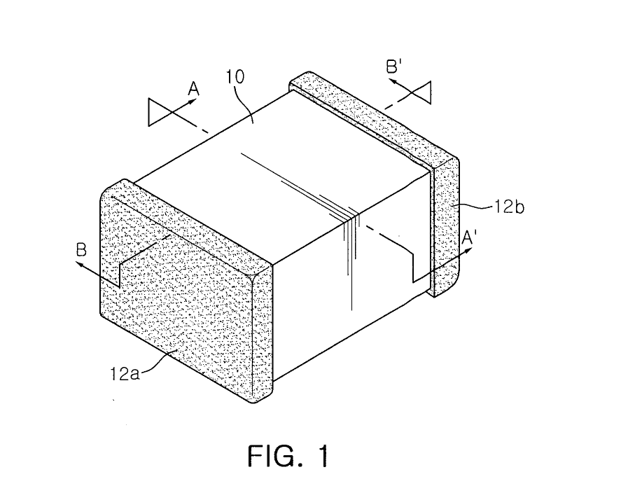

FIG. 1 is an external perspective view showing a layered inductor according to an exemplary embodiment of the present invention.

Referring to FIG. 1, a layered inductor according to an exemplary embodiment of the present invention is configured to include amain body 10 in which a plurality of non-magnetic layers are stacked, coil parts and magnetic paths in the main body, first and second external electrodes 12a and 12b connected to the coil parts.

According to the exemplary embodiment of the present invention, the main body 10 has a structure in which a plurality of non-magnetic layers are stacked, internal conductor patterns are formed on each of the non-magnetic layers and sequentially connected with each other through via electrodes to form the coil parts.

Further, according to the exemplary embodiment of the present invention, the coil parts are provided with a plurality of magnetic paths, i.e., paths through which magnetic flux induced by applying current to the coil parts passes.

The layered inductor, according to an exemplary embodiment of the present invention, has a terminal form and includes the main body having the structure in which the plurality of non-magnetic layers are stacked and the first external electrode 12a and the second external electrode 12b formed on two end surfaces of the main body and connected to the coil parts. In this configuration, the layered inductor is formed with a coil structure connected to the external electrodes while being disposed in a laminate.

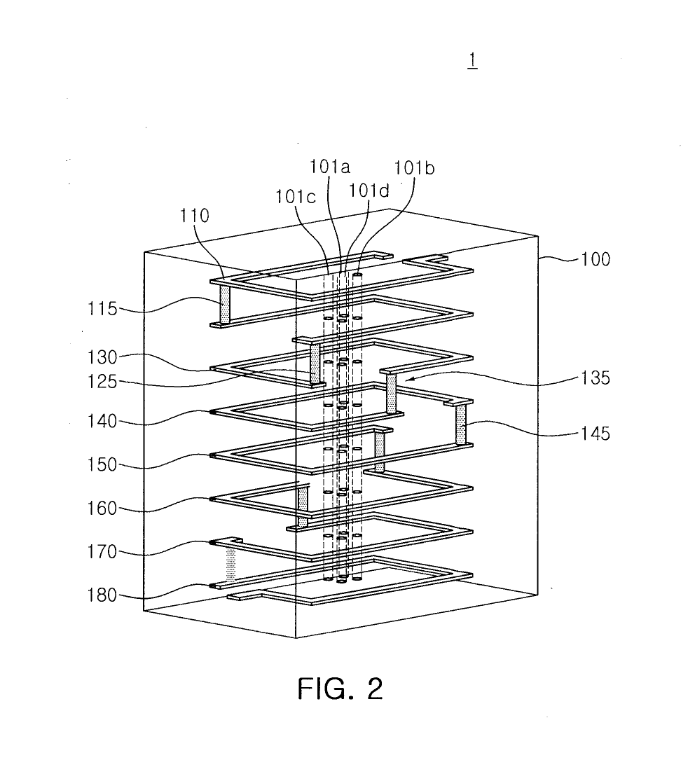

FIG. 2 is a perspective view of the layered inductor according to the exemplary embodiment shown in FIG. 1.

Referring to FIG. 2, the main body 100 includes conductor patterns 110, 120, 130, 140, 150, 160, 170, and 180, via electrodes 115, 125, 135, and 145, and first to fourth magnetic paths 101a, 101b, 101c, and 101d.

According to the exemplary embodiment of the present invention, the plurality of conductor patterns 110, 120, 130, 140, 150, 160, 170, and 180 are connected to the plurality of via electrodes 115, 125, 135, and 145 in the main body 100 to form the coil parts.

According to the exemplary embodiment of the present invention, a magnetic field is formed by applying electricity to the coil part and a magnetic flux penetrates through the center of the coil part according to the magnetic field.

According to the exemplary embodiment of the present invention, a plurality of magnetic paths 101a, 101b, 101c, and 101d are formed in the center of the coil part. The magnetic flux induced from the coil part may be concentrated on the plurality of magnetic paths 101a, 101b, 101c, and 101d.

Therefore, according to the related art, the magnetic flux is concentrated at the peripheral portions adjacent to the coil part, thereby making it possible to prevent the peripheral portions of the coil part from being magnetized. That is, the magnetic flux is concentrated at the central portion of the coil part, which can prevent the inductance characteristics of the coil from being affected due to the magnetization of the peripheral portions of the coil part.

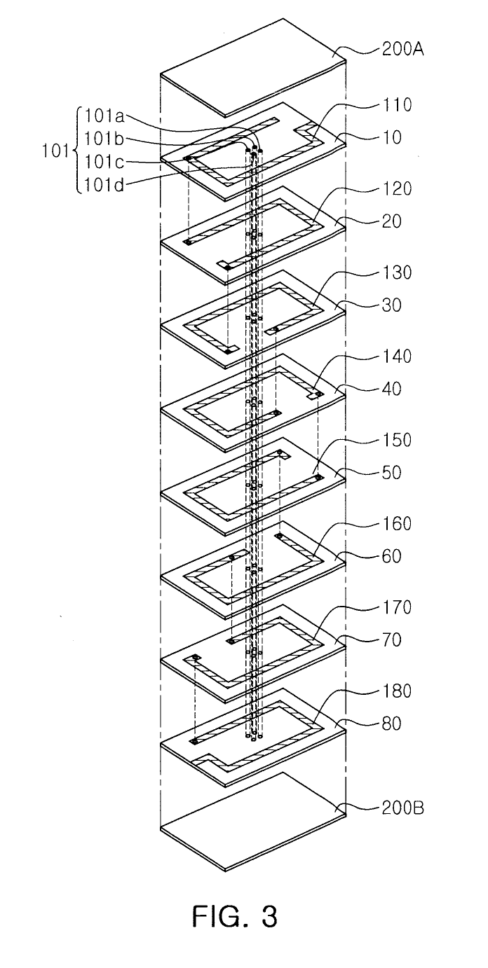

FIG. 3 is an exploded perspective view of the layered inductor according to the exemplary embodiment shown in FIG. 2.

According to the exemplary embodiment of the present invention, the layered inductor including the plurality of magnetic paths may be manufactured in order to prevent inductance characteristics of the coil from being deteriorated due to the magnetization of the peripheral portions of the coil part.

According to the exemplary embodiment of the present invention, the plurality of non-magnetic layers formed with the plurality of via electrodes and the conductor patterns are prepared.

According to the exemplary embodiment of the present invention, the non-magnetic layers 10, 20, 30, 40, 50, 60, 70, and 80 made of the non-magnetic material are used. The exemplary embodiment is not limited thereto, but may use the ceramic sheet made of the magnetic material.

Therefore, the magnetization phenomenon around the coil part, which is caused due to the use of the magnetic material in the related art, can be prevented.

Each of the non-magnetic layer are provided with the conductor patterns 110, 120, 130, 140, 150, 160, 170, and 180 and the via electrode. The conductor patterns 110, 120, 130, 140, 150, 160, 170, and 180 may be made of a conductive material having excellent electric conductivity and may have small and inexpensively realized resistivity.

The exemplary embodiment is not limited thereto and the conductor patterns may be any one of Ag, Pt, Pd, Au, Cu, and Ni or an alloy thereof.

According to the exemplary embodiment of the present invention, the conductor patterns are each connected to the via electrodes to form the coil structure.

When electricity is applied to the coil structure formed in the above-mentioned scheme, the magnetic field is formed in the coil part. In the case of the present invention, however, the main body is configured of the non-magnetic layer, such that the magnetic flux formed by the magnetic field does not pass through the main body but is shielded.

However, according to the exemplary embodiment of the present invention, the plurality of via holes are punched in the inner central portion surrounded by the conductor patterns formed on the non-magnetic layer and the plurality of via holes are filled with the magnetic material to form the plurality of magnetic paths 101 through which the magnetic flux passes.

The magnetic material is not limited thereto, but the via hole may be filled with the magnetic paste. Further, the magnetic material is not limited thereto but the magnetic paste may include a magnetic ceramic powder.

The layered inductor is completed by stacking the plurality of non-magnetic layers in order to form the coil structure by connecting the adjacent conductor patterns to the plurality of via electrodes and forming the first external electrode and the second external electrode connected to both ends of the coil structure.

It can be appreciated from FIG. 3 that the main body 100 of FIG. 2 is configured by stacking two cover magnetic layers 200A and 200B and eight non-magnetic layers 10, 20, 30, 40, 50, 60, 70, and 80 and four magnetic paths 101, 101b, 101c, and 101d are formed in the inner central portion surrounded by the conductor patterns 110, 120, 130, 140, 150, 160, 170, and 180 formed on the non-magnetic layers 10, 20, 30, 40, 50, 60, 70, and 80.

When electricity is applied to the layered inductor formed according to the exemplary embodiment of the present invention, the magnetic field is formed by the coil to pass the magnetic flux into the coil, but the layered inductor according to the exemplary embodiment of the present invention shields the magnetic flux induced by the coil since the main body is configured of the non-magnetic layers.

The magnetic flux formed by the coil is shielded by the non-magnetic layer, but the layered inductor partially passes the magnetic flux induced by the coil through the magnetic paths formed in the central portion of the coil. That is, according to the exemplary embodiment of the present invention, since the main body is configured of the non-magnetic layer, the magnetic flux to the peripheral portions adjacent to the coil part is shielded but the magnetic flux partially passes through the magnetic paths 101a, 101b, 101c, and 101d formed in the central portion.

As a result, the magnetic flux is only concentrated at the central portion to increase the density of the magnetic flux, and, in addition, the magnetic flux does not pass to the peripheral portions adjacent to the coil to prevent the inductance characteristics from being deteriorated due to the magnetization of the peripheral portions adjacent to the coil.

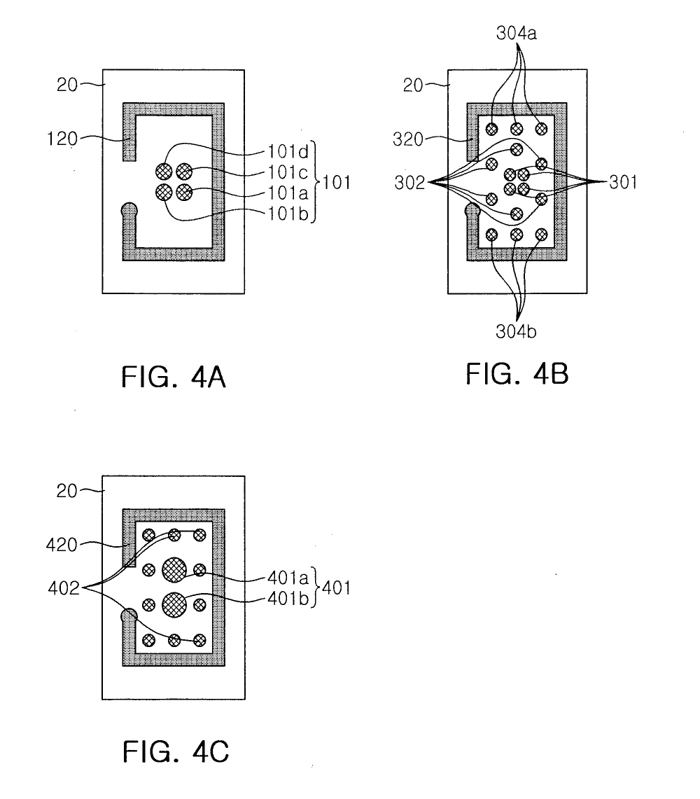

FIGS. 4A to 4C are plan views showing the magnetic paths formed on a non-magnetic sheet according to various exemplary embodiments of the present invention.

It can be appreciated from FIGS. 4A to 4C that the conductive patterns 120, 320, and 430 are formed on the non-magnetic layer 20 and the plurality of magnetic paths are formed in the inside surrounded by the conductor patterns 120, 320, and 430.

Referring to FIG. 4A showing the non-magnetic layer 20 on which the plurality of magnetic paths according to the exemplary embodiment of the present invention are formed, it can be appreciated that four magnetic paths 101 are formed in the inner central portion of the non-magnetic layer 20. The magnetic path 101 includes a first magnetic path 101a, a second magnetic path 101b, a third magnetic path 101c, and a fourth magnetic path 101d and is formed such that the magnetic flux penetrates through the central portion of the non-magnetic layer 20 from the inside of the coil.

According to the exemplary embodiment of the present invention, the plurality of via holes are formed in the inner central portion surrounded by the conductor pattern 120 formed on the non-magnetic layer 20 and are filled with the magnetic material.

In the case of the layered inductor manufactured by the above-mentioned method, the magnetic paths are formed in the inner central portion of the coil part, such that the magnetic flux induced by the coil may be concentrated at the central portion of the coil.

As a result, the magnetic flux is not formed in the coil peripheral portions, thereby making it possible to prevent the peripheral portions of the coil from being magnetized.

Referring to FIG. 4B showing the non-magnetic layer 20 on which the plurality of magnetic paths according to another exemplary embodiment of the present invention are formed, four magnetic paths 301 are formed in the inner central portion of the non-magnetic layer 20 and a first peripheral magnetic path 302 as well as second peripheral magnetic paths 304a and 304b are formed in the inner peripheral portion of the non-magnetic layer 20 to surround the central portion. In particular, the first peripheral magnetic path 302 is formed to surround four magnetic paths 301 formed in the central portion and the second peripheral magnetic paths 304a and 304b are formed to surround the first peripheral magnetic path 302.

According to the exemplary embodiment of the present invention, a number of via holes greater than that of the inner peripheral portions surrounded by the conductor pattern 320 are formed in the inner central portion surrounded by the conductor pattern 320 formed on the non-magnetic layer 20 and are filled with the magnetic material.

In the layered inductor manufactured by the above-mentioned method, since the inner central portion of the coil part includes a larger number of magnetic paths than the inner peripheral portion of the coil, the magnetic flux induced by the coil may be concentrated at the inner central portion of the coil.

As a result, the magnetic flux is not formed in the peripheral portions adjacent to the coil, thereby making it possible to prevent the peripheral portions of the coil from being magnetized.

Referring to FIG. 4C showing the non-magnetic layer 20 on which the plurality of magnetic paths according to another exemplary embodiment of the present invention are formed, two magnetic paths 401 having a large diameter are formed in the inner central portion of the non-magnetic layer 20 and the peripheral magnetic path 402 having a small diameter is formed in the inner peripheral portion of the non-magnetic layer 20 in order to surround the central portion thereof. In particular, the peripheral magnetic path 402 is formed to surround two magnetic paths 401 formed in the central portion.

According to the exemplary embodiment of the present invention, the via holes having a larger size than the inner peripheral portion of the conductor pattern 420 are formed in the inner central portion of the conductor pattern 420 formed on the non-magnetic layer 20 and are filled with the magnetic material.

In the case of the layered inductor manufactured by the above-mentioned method, since the inner central portion of the coil part includes the magnetic path having a larger size than the inner peripheral portion of the coil, the magnetic flux induced by the coil may be concentrated at the central portion of the coil.

As a result, the magnetic flux is not formed in the coil peripheral portions but the magnetic flux is concentrated at the central portion of the coil, thereby making it possible to prevent the peripheral portions of the coil from being magnetized.

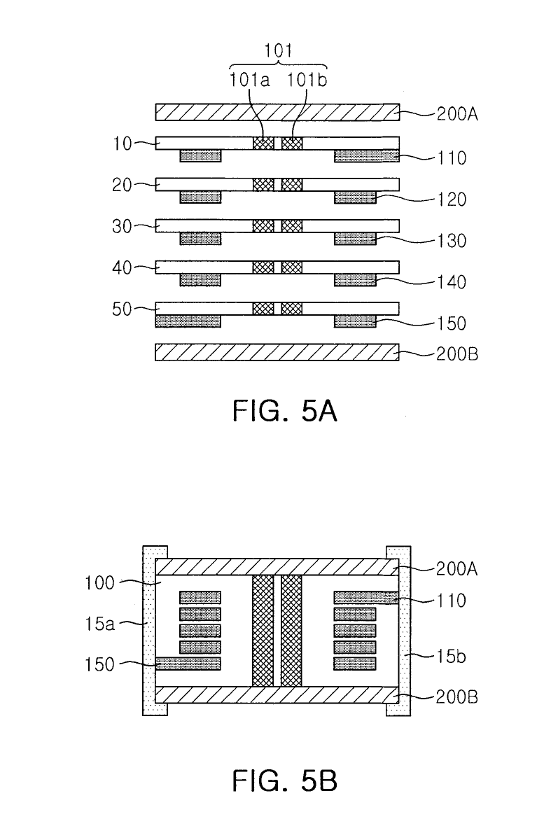

FIGS. 5A and 5B are cross-sectional views of a layered inductor according to the exemplary embodiment of the present invention.

FIG. 5A is an exploded cross-sectional view showing a shape in which the layered inductor according to the present invention is stacked and FIG. 5B is a cross-sectional view showing a cross-section of the layered inductor according to the present invention.

Referring to FIGS. 5A and 5B, the conductor patterns 110, 120, 130, 140, and 150 are formed on the non-magnetic layer 10, 20, 30, 40, and 50 and magnetic layers 200A and 200B that are a cover layer are stacked on the upper and lower portions of the non-magnetic layers 10, 20, 30, 40, and 50, thereby forming the main body of the layered inductor.

According to the exemplary embodiment of the present invention, since the non-magnetic layers 10, 20, 30, 40, and 50 are configured of the non-magnetic material, the magnetic flux induced by the coil does not pass through the non-magnetic layers 10, 20, 30, 40, and 50. As a result, it is possible to prevent the peripheral portions of the coil, that is, the peripheral portions of the conductor patterns from being magnetized.

According to the related art, the magnetic flux is shielded by stacking the magnetic layer and interposing the non-magnetic layer, i.e., a gap layer between the magnetic layers. On the other hand, according to the exemplary embodiment of the present invention, since the non-magnetic layer configures the main body, it is possible to shield the magnetic flux without forming the gap layer.

In the case of the layered inductor according to the related art, the inductance value is reduced while a DC-bias is increased, but in the case of the winding inductor, since the magnetic flux is limited by air, the variations of the inductance value is reduced by the effect of the opened magnetic path to improve the DC-bias characteristics.

However, in the case of the layered inductor according to the exemplary embodiment of the present invention, the main body is configured of the non-magnetic layer so that the magnetic flux is limited by the non-magnetic layer, variations of the inductance value are small even though DC-bias is increased by the effect of the opened magnetic path, thereby making it possible to improve the DC bias characteristics.

In addition, according to the exemplary embodiment of the present invention, since the plurality of magnetic paths 101a and 101b are formed in the center of the conductor patterns 110, 120, 130, 140, and 150, the magnetic flux induced by the coil is concentrated at the inner central portion surrounded by the conductor patterns.

Therefore, it is possible to prevent the magnetic flux from passing through the peripheral portions of the coil and thus, prevent the inductance characteristics of the inductor from being deteriorated due to the magnetization of the coil peripheral portion.

According to the exemplary embodiment of the present invention, since the laminate is configured of the non-magnetic layer and separately includes the magnetic paths to concentrate the magnetic flux at the central portion of the coil, it is possible to prevent the peripheral portion of the coil from being magnetized, thereby making it possible to prevent the inductance characteristics of the layered inductor from sharply being changed, similar to the winding inductor.

According to the exemplary embodiment of the present invention, it is possible to suppress the magnetization at high current to prevent the inductance value from being changed due to the application of current and it is possible to manufacture various types of layered inductors by changing the size of the internal magnetic path and the number of magnetic paths, thereby making it possible to manufacture various types of layered inductor with the improved inductance characteristics of the inductor.

As set forth above, the exemplary embodiment of the present invention provides the layered inductor with the improved inductance characteristics by shielding the magnetic flux flowing in the vicinity of the coil of the layered inductor to prevent the inductance (L) value of the layered inductor from being changed due to the magnetization of the vicinity of the coil at high current, and a manufacturing method thereof.

While the present invention has been shown and described in connection with the exemplary embodiments, it will be apparent to those skilled in the art that modifications and variations can be made without departing from the spirit and scope of the invention as defined by the appended claims.

What is claimed is:

1. A layered inductor, comprising:
a main body in which a plurality of non-magnetic layers are stacked;
coil parts having a plurality of conductor patterns and a plurality of via electrodes formed on the plurality of non-magnetic layers;
a plurality of magnetic paths formed in the coil parts and passing the magnetic flux induced from the coil parts therethrough; and
first and second external electrodes formed on the external surface of the main body to be connected to both ends of the coil part, respectively.

2. The layered inductor of claim 1, wherein the plurality of magnetic paths are formed in an inner central portion of the coil part to pass the magnetic flux induced from the coil part therethrough.

3. The layered inductor of claim 1, wherein the plurality of magnetic paths are formed in the inner central portion and the inner peripheral portion of the coil part to pass the magnetic flux induced from the coil part therethrough.

4. The layered inductor of claim 1, wherein the plurality of magnetic paths are formed in the inner central portion and the inner peripheral portion of the coil part to pass the magnetic flux induced from the coil part therethrough, and
the number of magnetic paths formed in the inner central portion of the coil part is set to be larger than that at the inner peripheral portion of the coil part to induce the flow of magnetic flux to the inner central portion of the coil part.

5. The layered inductor of claim 1, wherein the plurality of magnetic paths are formed in the inner central portion and the inner peripheral portion of the coil part to pass the magnetic flux induced from the coil part therethrough, and
the size of the magnetic path at the inner central portion of the coil part is set to be larger than that of the magnetic path at the inner peripheral portion of the coil part to induce the flow of magnetic flux to the central portion.

6. The layered inductor of claim 1, wherein the magnetic path includes a magnetic ceramic.

7. The layered inductor of claim 1, wherein the non-magnetic layer includes a non-magnetic ceramic sheet.

8. A manufacturing method of a layered inductor, comprising:
preparing a plurality of non-magnetic layers each formed to have a plurality of via electrodes and a plurality of conductor patterns;
punching a plurality of via holes in an inside surrounded by conductor patterns formed on the non-magnetic layers;
forming a plurality of magnetic paths by filling the plurality of via holes with a magnetic material;
stacking a plurality of non-magnetic layers to forma coil structure by connecting adjacent conductor patterns to the plurality of via electrodes; and
forming a first external electrode and a second external electrode at both ends of the stacked non-magnetic layer to be connected to both ends of the coil structure.

9. The manufacturing method of a layered inductor of claim 8, wherein during the punching of the via holes, the plurality of via holes are punched through the inner central portion surrounded by the conductor patterns.

10. The manufacturing method of a layered inductor of claim 8, wherein during the punching of the via holes, the plurality of via holes are punched through the inner central portion and the inner peripheral portion surrounded by the conductor patterns.

11. The manufacturing method of a layered inductor of claim 8, wherein during the punching of the via holes, the plurality of via holes are punched through the inner central portion and the inner peripheral portion surrounded by the conductor patterns, and
a larger number of via holes than that of the inner peripheral portion surrounded by the conductor patterns are punched through the inner central portion surrounded by the conductor patterns.

12. The manufacturing method of a layered inductor of claim 8, wherein during the punching of the via holes,
the plurality of via holes are punched through the inner central portion and the inner peripheral portion surrounded by the conductor patterns; and
the via holes having a larger size than the inner peripheral portion surrounded by the conductor pattern are punched through the inner central portion surrounded by the conductor patterns.

13. The manufacturing method of a layered inductor of claim 8, wherein the plurality of via holes are filled with a magnetic paste.

14. The manufacturing method of a layered inductor of claim 13, wherein the magnetic paste includes magnetic ceramic powder.

15. The manufacturing method of a layered inductor of claim 8, wherein the non-magnetic layer is a non-magnetic ceramic sheet.
